(19) United States
(12) Patent Application Publication
(10) Pub. No.: US 2025/0124900 A1
(43) Pub. Date: Apr. 17, 2025

(54) PERCUSSION DRUM AND DRUMHEAD

(71) Applicant: Loyal Drums, LLC, Fredericksburg, VA (US)

(72) Inventor: David Loyal, Woodbridge, VA (US)

(21) Appl. No.: 18/917,138

(22) Filed: Oct. 16, 2024

Related U.S. Application Data
(60) Provisional application No. 63/590,537, filed on Oct. 16, 2023.

(51) Int. Cl. G10D 13/20

(52) U.S. Cl. CPC G10D 13/20

(57) ABSTRACT

A percussion drum has a tubular shell with top and bottom ends. A drumhead overlays the top end of the shell. The drumhead includes a circular membrane. A rigid frame is crimped to the outer periphery of the membrane. A hoop presses down against the frame of the drumhead to increase tension in the membrane by way of a tension applicator. The tension applicator can be rope lacing in cooperation with sliding ears. The membrane of the drumhead comprises a multi-layer composite assembly having a UHMWP layer composed of randomly oriented fibers made from ultra-high molecular weight polyethylene. The UHMWP layer is sandwiched between upper and lower polyester layers. Optionally, a top layer of woven polyester overlays the upper polyester layer. The drumhead is less prone to producing intense repercussion shocks, so that players are at reduced risk of contracting tendinitis and other impact/overuse injuries, without sacrificing superior sound quality.

### CROSS REFERENCE TO RELATED APPLICATIONS

This application claims priority to U.S. Provisional Patent Application No. 63/590,537 filed on Oct. 16, 2023, the entire disclosure of which is hereby incorporated by reference and relied upon.

### BACKGROUND OF THE INVENTION

Field of the Invention. The invention relates generally to percussion drum of the type played as a musical instrument, and more particularly to a drumhead for such a drum.

Description of Related Art A drumhead is a membrane stretched taut over the open rim of a cylindrical shell. When struck (as with a drumstick or hand), the drumhead produces a reverberating percussion sound used in musical performances. Drumheads must be replaced at regular intervals due to wear or to achieve a desired musical characteristic. Drumheads are used for both performance drums and for practice drum pads.

Vintage drumheads were composed of various natural materials, commonly animal skin (typically calfskin or sheepskin). Natural materials have a favorable reputation for producing rich, warm tones and being highly responsive, but can be expensive and temperamental in use. Modern drumheads are fabricated from synthetic materials, including mylar, FiberSkyn® and Kevlar®. Synthetic drumheads have the advantage of being tough and durable, but lack the rich tonal qualities associated with the natural materials. Moreover, synthetic drumheads tend to be relatively thick so that they can sustain high tension loads needed for acceptable sound quality and feel. But when highly tensioned, synthetic drumheads become very hard resulting in repercussion shocks that travel up the drummer's arm. Over time, these shock waves can produce tendinitis and other adverse health consequences. Functionally, the relative thickness of a synthetic drumhead adversely affects its responsiveness and the subjective “feel” experienced by a player.

The drumhead plays a key role in the musical experience for the player of percussion drums, and yet is the primary factor leading to repetitive stress injuries that tend to manifest in the player's elbows, wrists, hands and shoulders. Drummers, drum students and instructors would therefore benefit from any improvement that will enhance the overall experience while reducing the risk of injury. More specifically, there is a need in the art for an improved drum and drumhead that produces warm percussion tones, that is durable and responsive but without the medical issues associated with modern synthetic options, and that generates a feel that is ergonomic and consistent with the best natural and synthetic materials.

### BRIEF SUMMARY OF THE INVENTION

According to a first aspect of this invention, a drumhead is provided for a percussion drum of the type played as a musical instrument. The drumhead comprises a membrane having a generally circular playing field surrounded by an outer periphery. The outer periphery is generally circular. A frame fixedly connected to the outer periphery. The membrane of the drumhead comprises a multi-layer composite assembly having at least one UHMWP layer composed of fibers made from ultra-high molecular weight polyethylene.

According to a second aspect of this invention, a percussion drum is provided of the type played as a musical instrument. The percussion drum comprises a generally tubular shell having a top end and a bottom end. A drumhead overlays the top end of the shell. The drumhead comprises a membrane that has a generally circular playing field surrounded by an outer periphery. A frame is fixedly connected to the outer periphery. The frame has a frame diameter. A hoop is in operative engagement with the drumhead. The hoop has a generally cylindrical body that extends longitudinally between a foot and a rim. The foot has a diametrical span generally equal to the frame diameter. A tension applicator is configured to adjustably tension the playing field of the drumhead across the top end of the shell. The membrane of the drumhead comprises a multi-layer composite assembly having at least one UHMWP layer composed of fibers made from ultra-high molecular weight polyethylene.

The drumhead configured with the membrane of this invention produces unexpected orthopedic benefits. The drumhead of the present invention is substantially less prone to producing intense repercussion shocks, so that players are at reduced risk of contracting tendinitis and other adverse health consequences. Moreover, the novel drumhead can be tensioned through adjustment to mimic the feel of any performance type drum, including performance options that can only be achieved at the highest tension values. Still further, the membrane of the drumhead can be made ultra-thin, which has the advantage of producing superior sound quality with every stroke and every note.

### BRIEF DESCRIPTION OF THE SEVERAL VIEWS OF THE DRAWINGS

These and other features and advantages of the present invention will become more readily appreciated when considered in connection with the following detailed description and appended drawings, wherein:

FIG. 1 is a perspective view of a drum according to an embodiment of the invention;

FIG. 2 is a perspective view of a drumhead according to an embodiment of the invention;

FIG. 3 is an exploded, fragmentary, cross-sectional view through the top end of the drum showing the hoop and drumhead separated from the shell;

FIG. 4 is a cross-sectional view as in FIG. 3 but taken generally along lines 4-4 of FIG. 1 showing the hoop, drumhead and shell in an assembled condition for use;

FIG. 5 is a partially sectioned view of the membrane portion of the drumhead;

FIG. 6 is a fragmentary, cross-sectional view taken generally along lines 6-6 of FIG. 2;

FIG. 7 is an enlarged view corresponding to the area circumscribed at 7 in FIG. 5, showing the multi-layer composite assembly of the membrane according to an embodiment of the invention;

FIG. 8 is a simplified schematic view, in the exploded style, showing the multi-layer composite assembly of the membrane according to an embodiment of the invention; and

FIGS. 9A-D show various schemes of applied dampening glue to alter the acoustics of the drumhead.

### DETAILED DESCRIPTION OF THE INVENTION

Referring to the figures, wherein like numerals indicate like or corresponding parts throughout the several views, a percussion drum of the type played as a musical instrument is generally shown at 10. The drum 10 includes a shell, generally indicated at 12, which forms the body of the drum 10. The shell 12 is relatively thin walled, having a generally tubular or cylindrical shape in most cases. However, other contemplated embodiments, the shell 12 could be formed with a bulging curvature (e.g., barrel-shaped), or a narrow-waisted curvature (e.g., hourglass-shaped) and or a tapered shaped, as well as many other variations known to those of skill in the art. Indeed, many geometric variations of the shell 12 are possible. Moreover, the shell 12 can be made from any suitable material, including but not limited to solid or laminated veneers of wood, staves of wood, formed plywood, polymer sheet and the like.

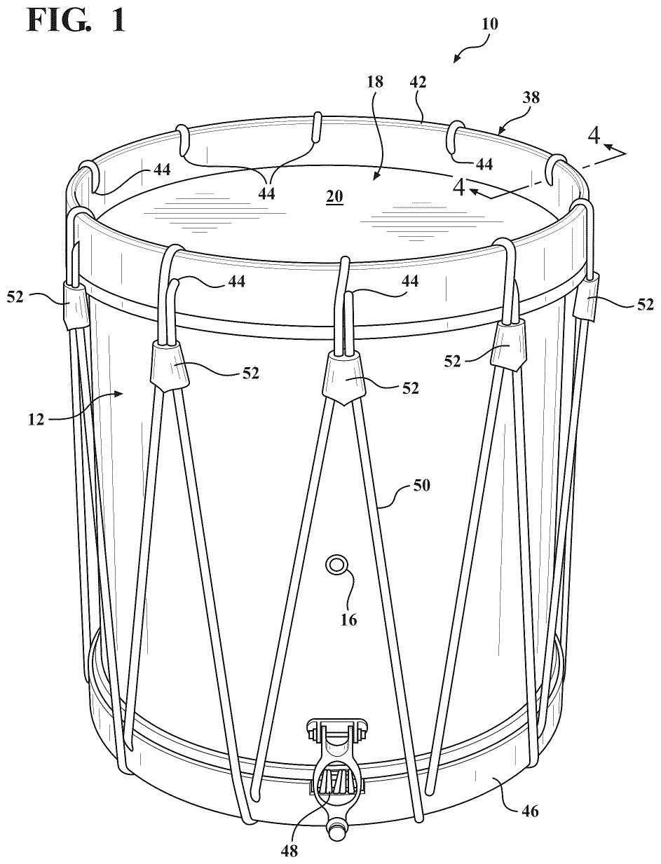

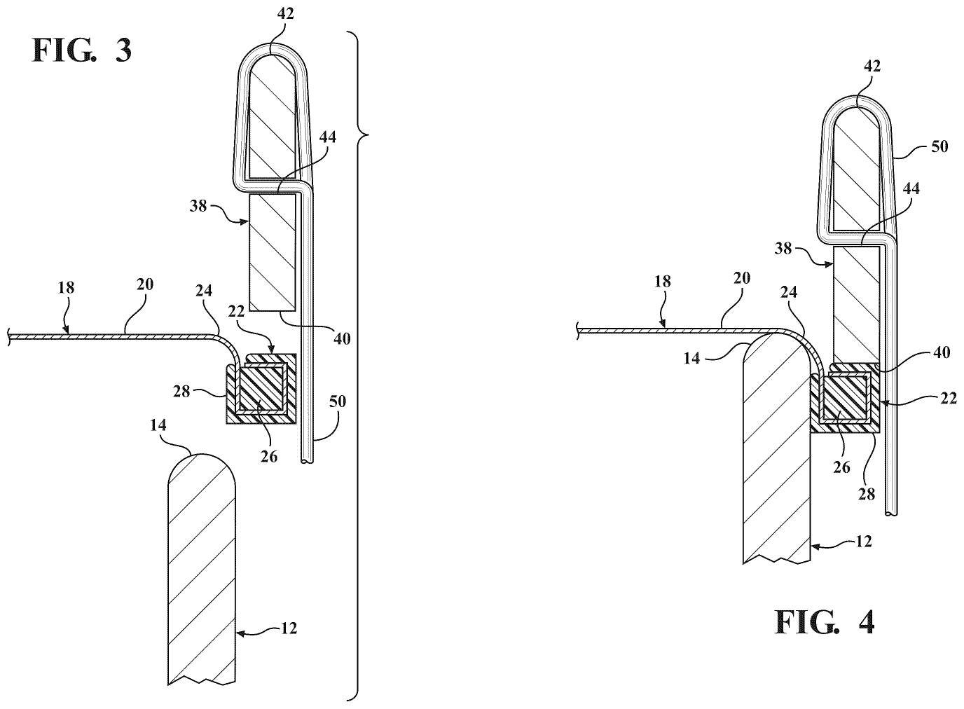

The shell 12 has a top end 14 and a bottom end. As best seen in the cross-sectional views of FIGS. 3 and 4, the top edge 14 is preferably gently rounded or otherwise profiled with a bullnose shape, for reasons that will become apparent. A vent hole 16 may be disposed in the shell 12, generally mid-way between the top 14 and bottom ends, as depicted in FIG. 1.

Although the bottom edge is not clearly visible in the figures, it is contemplated that the bottom edge is either identical to the top edge 14 or at least generally similar to the top edge 14. Thus, descriptions of the top edge 14 can be understood as applying with reasonable equality to the bottom edge as well.

The drum 10 includes a drumhead, generally indicated at 18, which is designed to be stretched taught over the top end 14 of the shell 12. The drumhead 18 is the traditional playing surface of the drum 10, designed to be struck rhythmically by the tips of handheld drumsticks (not shown) or other striking devices. The drumhead 18 is a wear part of the drum 10, requiring occasional replacement due to stretching, tears and punctures.

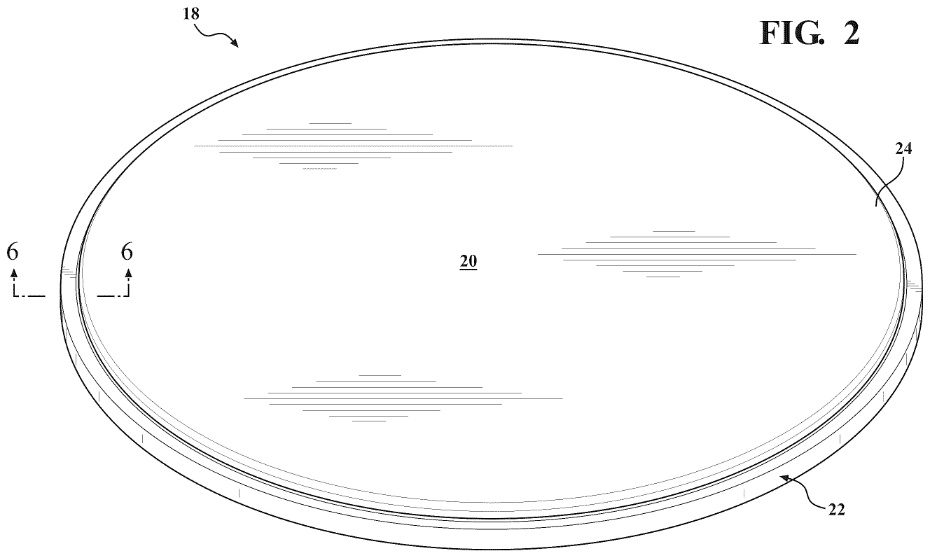

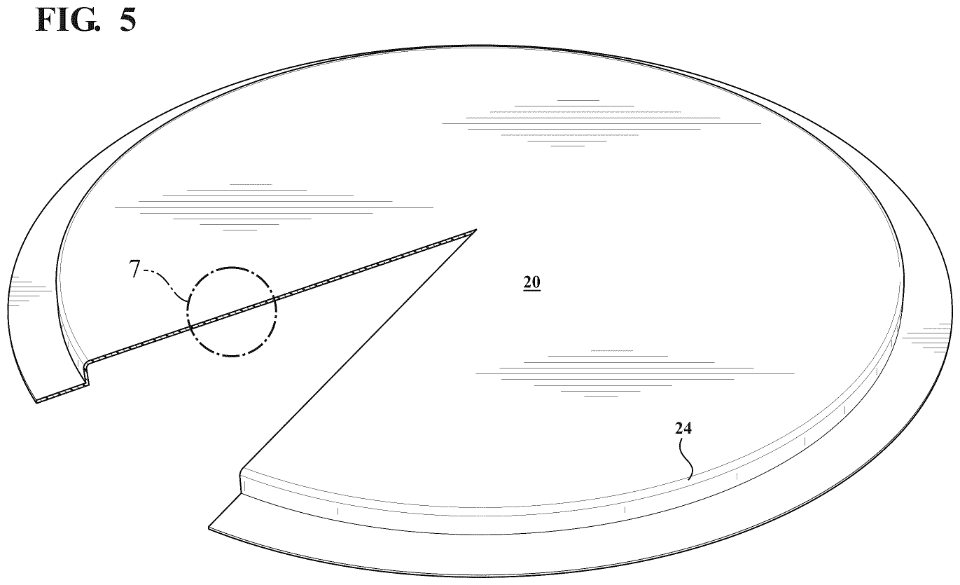

The drumhead 18 is an assembly composed of a membrane 20 and a frame 22. Both frame 22 and membrane 20 are visible in FIG. 2. The membrane 20, shown by itself and partially sectioned in FIG. 5, has a central playing field surrounded by an outer periphery. In most contemplated embodiments, the outer periphery is generally circular, as in the playing field. In some embodiments, the membrane 20 can be formed with a collar bend 24. The collar bend 24 delineates the playing field from the outer periphery and establishes a gentle curve leading into the frame 22, as perhaps best seen in FIGS. 3 and 4. The collar bend 24 can be established by trapping the membrane 20 in a heated mold, or otherwise applying heat while shaping around a form.

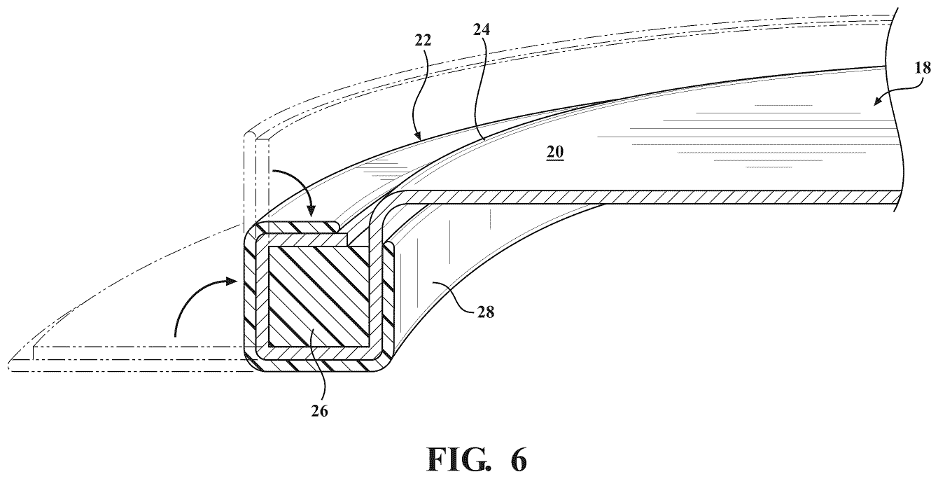

The frame 22 is a rigid, ring-like member having a frame diameter adapted to slide over and encircle the top end 14 of the shell 12. The frame 22 can be made of any suitable material, including metals and alloys thereof, wood, plastic, and fiber-reinforced composites to name a few. The frame 22 is fixedly connected to the outer periphery of the membrane 20 by any suitable bonding or attachment technique. One common method is to glue the outer periphery of the membrane into a channel of the frame. However, in the illustrated examples, in particular FIG. 6, fixation is accomplished by mechanical crimping. In this case, the frame 22 is comprised of a core 26 and a jacket 28. The core 26 is sized to slip over the collar bend 24. The partially formed jacket 28 is then positioned underneath the membrane, effectively sandwiching the outer periphery of the membrane 20. Through a simple multi-stage bending process that can be discerned by reference to the broken-line features and directional arrows, part of the jacket 28 together with the outer periphery of the membrane 20 are folded around the core 26. The illustration suggests but one bending scheme, while in fact other schemes may be possible. Sufficient pressure is applied so that the jacket 28 compresses the outer periphery of the membrane 20 against the core 26. The core 26 shown in FIGS. 3, 4 and 6 has a generally square cross-sectional shape, which provides significant gripping power to prevent slippage between the frame 22 and membrane 20. However, it will be appreciated that the core 26 could be designed to have a different cross-sectional shape.

Returning to FIG. 4, it will be appreciated that in use, the drumhead 18 overlays the open top end 14 of the tubular shell 12. The outer diameter of the shell 12 at the top end 14 is smaller than the inner diameter of the frame 22 of the drumhead 18 so that only the membrane 20 contacts the top end 14 in the region of its collar bend 24, thus centering the drumhead 18 over the shell 12.

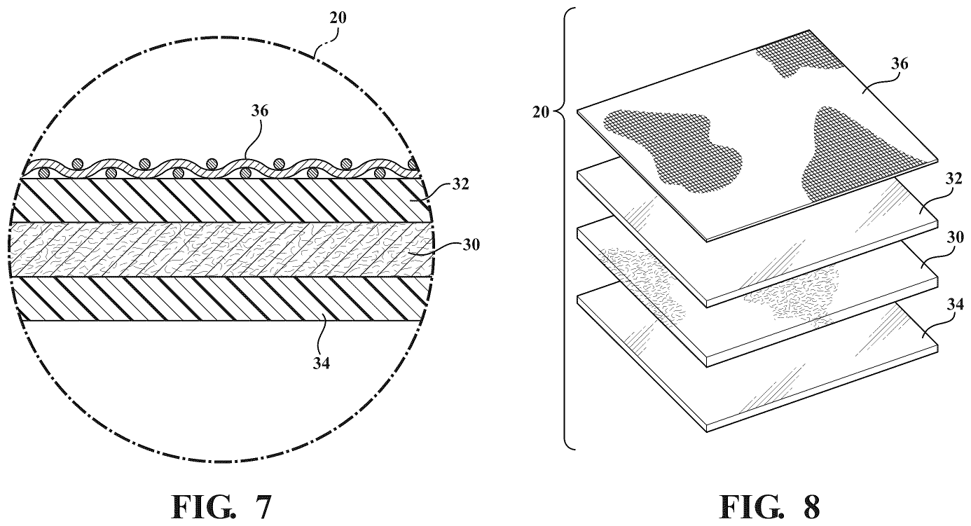

An important aspect of this invention is the composition of the membrane 20. Turning now to FIGS. 7 and 8, the membrane 20 of the drumhead 18 is shown comprising a multi-layer composite assembly having at least one UHMWP layer 30 composed of fibers made from ultra-high molecular weight polyethylene. The fibers in the UHMWP layer 30 are non-woven. That is, the ultra-high molecular weight polyethylene fibers within the UHMWP layer 30 are randomly oriented. The UHMWP layer 30 is laminated between two sheets of polyester 32, 34. That is to say, the membrane 20 includes upper 32 and lower 34 polyester layers disposed on opposite sides of the UHMWP layer 30. The upper 32 and lower 34 polyester layers may be generally transparent, however embodiments are contemplated in which one or both polyester layers 32, 34 are semi-transparent or opaque. The three layers 32-30-34 comprise the membrane 20. In some contemplated embodiments, the membrane 20 may also include a top layer 36 overlying the upper polyester layer 32. When included in the multi-layer composite of the membrane 20, the top layer 36 comprises woven strands of polyester. Thus it is to be understood that that the top layer 36 is an optional component of the membrane 20, and when included is preferably of woven polyester construction.

Sheets composed of a UHMWP layer 30 laminated between two sheets of polyester 32, 34 are sold commercially for non-musical instrument applications under the trade names Dyneema® and Cuben Fiber®. Dyneema® is a trademark of DSM IP Assets B.V. (Netherlands). Cuben Fiber® is a trademark of North Cuben Fiber, LLC (Connecticut). Sometimes, sheet goods of this type are referred to as DCF fabric. Although DCF fabric is known for such applications as sailcloth and high-performance outdoor gear and clothing, DCF fabric has never been considered for use in connection with musical instruments, and more specifically percussion drums.

Of the many notable advantages discovered by the use of DCF fabric for the membrane 20 of the drumhead 18, perhaps chief among them are the ability to achieve a rich percussion sound and responsiveness achievable only by highly tensioning the membrane 20, but without the adverse shock repercussions and resulting player injuries. As previously mentioned, modern prior art drumheads fabricated from synthetic materials such as mylar and Kevlar® tend to become very hard when highly tensioned. The hardness of the prior art synthetic membrane produces repercussion shocks that travel up the drummer's arm. Over time, these shock waves produce tendinitis and other very severe, disabling consequences. Skilled musicians also often complain that the responsiveness and the subjective feel of a prior art synthetic membrane is poor in comparison to more traditional natural membrane materials like calfskin.

A particular advantage of a membrane 20 composed of DCF fabric is the avoidance of repercussion shocks, and thus the avoidance of player injury, without sacrificing the highly desirable rich percussion sound and responsiveness demanded by highly skilled players. Because of its DCF membrane 20, which is composed of some of the strongest fibers on earth, the membrane 20 can be a fraction of the thickness of a conventional membrane 20 but allow for more tension. In the past, high tension could be achieved only by using a Kevlar® head, but at the expense of feeling very hard and producing adverse shock waves for the user. The DCF membrane 20 has been found to match the responsiveness of a prior art ultrathin membranes but without the durability issues of ultrathin membranes. The DCF membrane 20 can match the high tension of a Kevlar head without the medical issues just mentioned. The DCF membrane 20 mimics the feel of playing on calfskin without the temperament issues of calfskin. Thus, the drumhead 18 equipped with a DCF membrane 20 is well-suited for use on vintage style rope-tensioned drums, as well as modern high-tension marching drums, frame 22 drums, or any other musical percussion instrument where tension and feel need to coexist, and players are at risk of repercussion shock injuries.

Another interesting advantage of a membrane 20 composed of DCF fabric is its ability to accept over-the-counter stains. Whereas modern prior art drumheads fabricated from synthetic materials such as mylar and Kevlar® are generally impervious to end-user color alterations, a membrane 20 composed of DCF fabric will readily accept coloring stains. Unlike paints which coat the membrane, stains penetrate into the fibers. As a consequence, stains neither impair sound quality nor do they suffer ill-affects of vibration. Players are therefore liberated to personalize their drumheads 18 with stains. This option is particularly attractive to players of historical/traditional drums 10 like that shown in FIG. 1, where the membrane 20 can be stained to replicate the look of natural calfskin.

Moreover, the Applicant has discovered use of DCF fabric for the membrane 20 produces still other new, unexpected and surprisingly beneficial results that are unrelated to the well-known commercial benefits of DCF fabric. It has been discovered that certain unique characteristics of DCF fabric make it conducive to use as a drumhead 18 due to its high-tension, high-strength and low-weight. These compelling features, which have never been used for the application of drumheads 18, make DCF fabric unique and commercially viable. As a high-performance, non-woven composite material, DCF fabric produces longer lasting drumheads 18, improves sound quality, produces a characteristically unique sound, and an overall quality that will be attractive to drummers at all levels. Drumheads 18 fabricated with DCF membranes 20 yield a distinctive look, superior quality, robust durability and unique sound.

The drum 10 further includes a hoop 38 in operative engagement with the drumhead 18. The hoop 38 is a generally annular or ring-shaped member designed to apply downward pressure on the frame 22 of the drumhead 18, which in turn causes the membrane 20 to be stretched across the top end 14 of the shell 12. As can be appreciated from FIG. 4, more downward pressure on the frame 22 means more tension on the membrane 20, and vice versa.

The hoop 38 has a generally cylindrical body extending, in the longitudinal direction, between a foot 40 and a rim 42. The foot 40 has a diametrical span that is generally equal to the diameter of the frame 22 so that the can be brought into contact with one another, as shown in FIGS. 3 and 4. The rim 42 can be formed with a rounded, or bull nose, profile to improve tactile feel and appearance.

In some embodiments, including those illustrated in the accompanying figures, plurality of tensioning holes 44 are formed in the hoop 38. The example of FIG. 1 depicts a hoop 38 having ten (10) tensioning holes 44. The number of tensioning holes 44 can vary depending on overall scale and design choice. The tensioning holes 44 can be located generally midway between the foot 40 and the rim 42, or at any other suitable longitudinal location exposed above the drumhead 18. Moreover, the tensioning holes 44 are, preferably, equally circumferentially spaced apart from one another to better equalize the distribution of downward force around the hoop 38 and that is applied to the frame 22. The hoop 38 may be made of wood, polymer, metal or any other suitable material.

Optionally, the drum 10 may be configured with a second drumhead overlaying the bottom end of the shell 12, and a second hoop 46 in operative engagement with the second drumhead. Although the second drumhead is not visible in FIG. 1, those of skill in the art will appreciate that the second drumhead can be substantially identical to the previously described drumhead 18, and that the second hoop 46 can be substantially identical to the previously described hoop 38. In some cases, the drum 10 can be played from either the top end 14 or the bottom end. However, play from the bottom end would not be anticipated in the example of FIG. 1, which the design indicates inclusion of an optional snare assembly 48 passing through a notch or relief in the second hoop 46. As is well known, the snare assembly 48 includes a number of elongated spring-like elements that extend across the second drumhead 18 and produce the traditional rattling sound characteristic of snare-type drums.

The drum 10 further includes a tension applicator configured to adjustably stretch the playing field of the membrane 20 across the top end 14 of the shell 12. In cases where the drum 10 includes a second drumhead located at the bottom end, the tension applicator can be configured to simultaneously, and more-or-less equally, tension both drumheads. The sound quality and responsiveness of the drumhead 18 is controlled to a large extent by the amount of tension imposed on the membrane 20.

The tension applicator may comprise any number of well-known devices and techniques, including modern bolt tensioners. In a modern bolt tensioning system, the shell 12 is held in compression by a plurality of bolt-like tuning rods matched with threaded lugs. In order to tighten and tune the drumhead 18, a suitable tool (e.g., allen wrench) is used to screw the tuning rods into the lugs, thus drawing the hoop 38 toward the bottom end and in turn causing the DCF membrane 20 to be pulled in ever-tightening increments over the top end 14 of the shell 12. The threaded inserts can be selected of a standardized size that will enable common use of adaptable under-mounting arrangements, such as cymbal stands, basket stands, tripods, and the like. One or more threaded inserts can be established on the hoop 38 to high-mount ancillary equipment.

In the illustrated embodiment, the tension applicator comprises a traditional scheme of cable or rope 50. In lacing fashion the rope 50 passes through each of the tensioning holes 44 in the hoop 38. And if the drum 10 is configured with a second hoop 46 as in FIG. 1, the rope 50 will also pass through the tensioning holes in the second hoop 46. Preferably in this case, the tensioning holes in the second hoop 46 are offset from the tensioning holes 44 in the hoop 38 to create an aesthetically pleasing and balanced back-and-forth laced look. The rope 50 loops over the rim 42 of the hoop 38, adjacent each the tensioning hole 44.

To effectuate the tensioning action in traditional rope tensioning schemes, a plurality of cars 52 are employed. Typically, the number of cars 52 will be equal to the number of tensioning holes 44 in the hoop 38. The example of FIG. 1 depicting a hoop 38 having ten (10) tensioning holes 44, is fitted with ten (10) cars 52. Each car 52 straddles the two descending strands of rope 50 below the associated tensioning hole 44. Forcefully moving the car 52 toward the bottom end of the shell causes the strands of rope 50 to be pulled together, and thereby apply increasing tensile stress on the rope 50. The ears 52 are designed to remain in a set position by friction.

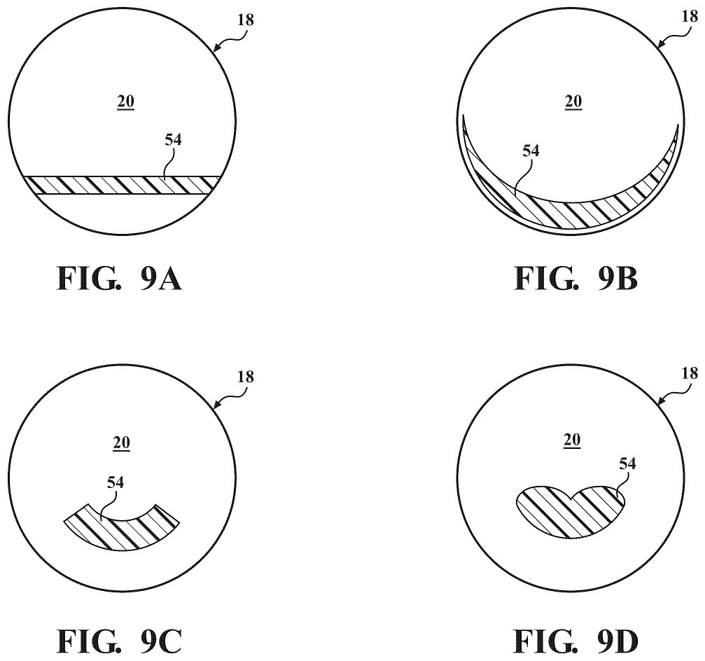

Turning now to FIGS. 9A-D, various strategies for alter the acoustics of the drumhead 18 are suggested. The DCF membrane 20 is receptive to integrated muffling strategies. In each of FIGS. 9A-D, the underside of the drumhead 18 appears with a thin layer of dampening agent 14 applied over a limited region. The dampening agent 14 can be any type of muffling agent suitable for the application. Dampening agents 14 may sometimes be referred to as green glue, or acoustic caulk. The shape of the region over which the dampening agent is applied will influence the acoustics of the drum 10. The various shapes shown in FIGS. 9A-D are but a few of the many possibilities. Those of skill in the art will envision many alternatives.

A primary advantage of a drumhead 18 configured with a DCF membrane 20 is found in its surprising orthopedic benefits. As previously mentioned, the DCF membrane 20 allows for a greater range of tension, which is attractive to players that prefer very high tension levels. It is well-known, however, that prior art synthetic membranes under high tension produce intense repercussion shocks that travel up the drummer's arm which, over time, can provoke tendinitis and other adverse health consequences. The drumhead 18 of the present invention, having a DCF membrane 20, is substantially less prone to producing intense repercussion shocks. As a direct consequence, players are less likely to contract tendinitis and other adverse health consequences.

And there are many additional benefits to mention. The use of a DCF membrane 20 ideally mimics the feel of any performance type drum—i.e., concert, marching, rope, etc. —by simply adjusting the tension of the membrane 20 through actuation of tension applicator fitted to the drum 10. The DCF membrane 20 is capable of being stretched to high tension values, which expands the performance options available to players. A drum 10 fitted with a DCF membrane 20 is well-suited for the rudimental, modern, and concert drummer, be they novice or expert or anywhere in-between.

The DCF membrane 20 can be very thin, much thinner than comparable synthetic membranes of the prior art. The ultra-thin nature of the DCF membrane 20 produces superior sound quality with every stroke and every note.

The foregoing invention has been described in accordance with the relevant legal standards, thus the description is exemplary rather than limiting in nature. Variations and modifications to the disclosed embodiment may become apparent to those skilled in the art and fall within the scope of the invention.

What is claimed is:

1. A drumhead for a percussion drum of the type played as a musical instrument, said drumhead comprising:
a membrane having a generally circular playing field surrounded by an outer periphery, said outer periphery being generally circular, a frame fixedly connected to said outer periphery,
said membrane of said drumhead comprising a multi-layer composite assembly having at least one UHMWP layer composed of fibers made from ultra-high molecular weight polyethylene.

2. The drumhead of claim 1, wherein said membrane includes upper and lower polyester layers disposed on opposite sides of said UHMWP layer.

3. The drumhead of claim 2, wherein at least one of said upper and lower polyester layers are generally transparent.

4. The drumhead of claim 2, wherein said membrane includes a top layer overlying said upper polyester layer, said top layer comprising woven strands of polyester.

5. The drumhead of claim 1, wherein said fibers in said UHMWP layer are randomly oriented.

6. The drumhead of claim 1, wherein said frame is comprised of a core and a jacket.

7. The drumhead of claim 6, wherein said outer periphery of said membrane is folded around said core, said jacket compressing said outer periphery of said membrane against said core.

8. The drumhead of claim 1, wherein said membrane has a collar bend between said playing field and said outer periphery.

9. The drumhead of claim 1, wherein said membrane has an underside, further including a thin layer of dampening agent applied over a limited region of said underside.

10. A percussion drum of the type played as a musical instrument, said percussion drum comprising:
a shell, said shell being generally tubular having a top end and a bottom end,
a drumhead overlaying said top end of said shell, said drumhead comprising a membrane having a generally circular playing field surrounded by an outer periphery, a frame fixedly connected to said outer periphery, said frame having a frame diameter,
a hoop in operative engagement with said drumhead, said hoop having a generally cylindrical body extending longitudinally between a foot and a rim, said foot having a diametrical span generally equal to said frame diameter,
a tension applicator configured to adjustably tension said playing field of said drumhead across said top end of said shell,
said membrane of said drumhead comprising a multi-layer composite assembly having at least one UHMWP layer composed of fibers made from ultra-high molecular weight polyethylene.

11. The percussion drum of claim 10, wherein said membrane includes upper and lower polyester layers disposed on opposite sides of said UHMWP layer, said fibers in said UHMWP layer being randomly oriented.

12. The percussion drum of claim 11, wherein said membrane includes a top layer overlying said upper polyester layer, said top layer comprising woven strands of polyester.

13. The percussion drum of claim 10, wherein said outer periphery of said membrane is generally circular, said membrane having a collar bend between said playing field and said outer periphery, said frame being comprised of a core and a jacket, said core having a generally square cross-sectional shape, said outer periphery of said membrane being folded around said core, said jacket compressing said outer periphery of said membrane against said core.

14. The percussion drum of claim 10, wherein said hoop includes a plurality of tensioning holes, said tensioning holes being located generally midway between said foot and said rim, said tensioning holes being equally circumferentially spaced apart from one another, said tensioning holes being exposed above said drumhead.

15. The percussion drum of claim 14, wherein said tension applicator comprises a rope, said rope passing through each of said tensioning holes in said hoop, said rope looping over said rim adjacent each said tensioning hole, a plurality of ears, each said ear configured to apply tensile stress on said rope.

16. The percussion drum of claim 10, further including a second drumhead overlaying said bottom end of said shell, and a second hoop in operative engagement with said second drumhead.

17. The percussion drum of claim 16, further including a snare assembly passing through said second hoop and extending across said second drumhead.

18. A percussion drum of the type played as a musical instrument, said percussion drum comprising:
a shell, said shell being generally tubular having a top end and a bottom end, said top end having a bull nose profile, said bottom end having a bull nose profile, a vent hole disposed in said shell between said top and bottom ends,
a drumhead overlaying said top end of said shell, said drumhead comprising a membrane having a generally circular playing field surrounded by an outer periphery, said outer periphery being generally circular, said membrane having a collar bend between said playing field and said outer periphery, a frame fixedly connected to said outer periphery, said frame having a frame diameter,
said membrane of said drumhead comprising a multi-layer composite assembly having at least one UHMWP layer composed of fibers made from ultra-high molecular weight polyethylene, said fibers in said UHMWP layer being randomly oriented, said membrane including upper and lower polyester layers disposed on opposite sides of said UHMWP layer,
a hoop in operative engagement with said drumhead, said hoop having a generally cylindrical body extending longitudinally between a foot and a rim, said foot having a diametrical span generally equal to said frame diameter, said rim having a bull nose profile, a plurality of tensioning holes formed in said hoop, said tensioning holes being located generally midway between said foot and said rim, said tensioning holes being equally circumferentially spaced apart from one another, said tensioning holes being exposed above said drumhead, and
a tension applicator configured to adjustably tension said playing field of said drumhead across said top end of said shell, said tension applicator comprising a rope, said rope passing through each of said tensioning holes in said hoop, said rope looping over said rim adjacent each said tensioning hole, a plurality of ears, each said ear configured to apply tensile stress on said rope.

19. The percussion drum of claim 18, wherein said frame comprises a core and a jacket, said core having a generally square cross-sectional shape, said outer periphery of said membrane being folded around said core, said jacket compressing said outer periphery of said membrane against said core, said membrane including a top layer overlying said upper polyester layer, said top layer comprising woven strands of polyester.

20. The percussion drum of claim 18, further including a second drumhead overlaying said bottom end of said shell, a second hoop in operative engagement with said second drumhead, wherein said membrane has an underside, and further including a thin layer of dampening agent applied over a limited region of said underside.
